(19) United States
(12) Patent Application Publication
(10) Pub. No.: US 2018/0139493 A1
(43) Pub. Date: May 17, 2018

(54) METHOD FOR SETTING THE LEVEL OF DEFINITION OF THE IMAGES OF A MULTIMEDIA PROGRAMME

(71) Applicant: VIACCESS, Paris La Defence Cedex (FR)

(72) Inventors: Chem Assayag, Paris (FR); Giles Dubroeucq, Saint-Piat (FR)

(73) Assignee: VIACCESS, Paris La Defense Cedex (FR)

(21) Appl. No.: 15/571,387

(22) PCT Filed: May 3, 2016
(86) PCT No.: PCT/EP2016/059822

§ 371 Date: Nov. 2, 2017

(30) Foreign Application Priority Data
May 5, 2015 (FR) 15 54020

(51) Int. Cl. H04N 21/431; H04N 21/235; H04N 21/485

(52) U.S. Cl. CPC H04N 21/4312; H04N 21/4854; H04N 21/2353

(57) ABSTRACT

The invention concerns a method for setting the level of definition of at least one image of a multimedia programme displayed on a screen of a terminal provided with at least one unit for characterising the multimedia programme and at least one unit for selecting predefined settings. This method comprises the following steps: the characterisation unit automatically acquires metadata attached to said multimedia programme and submits said data to the unit for selecting predefined settings, the unit for selecting predefined settings automatically selects the settings according to pre-recorded rules defined depending on the values of said metadata.

### TECHNICAL FIELD

The invention relates to the field of processing images displayed by video viewing equipment (TV, Media Players, set top boxes, or any other equivalent device) or still images and more specifically relates to a method for setting the level of definition of at least one image of an audiovisual programme displayed on a screen of a terminal provided with at least one unit for characterising the programme and at least one unit for selecting predefined settings.

The invention also relates to a terminal for viewing at least one image of an audiovisual programme including at least one screen, at least one unit for characterising the programme, and at least one unit for selecting predefined settings of said image.

The invention also relates to a computer programme stored on a recording medium including instructions for implementing the steps of the method according to the invention when run on a computer.

### STATE OF PRIOR ART

To set the level of definition of the displayed images of a broacast programme or a programme read from a recording medium, terminals of prior art (television set or TV set top boxes, computer, tablets, or mobile phone) provide upscaling processings to convert multimedia programmes having a lower definition to the native definition of the screen of the terminal used by interpolating in a more or less elaborate manner the intermediate pixels. That is the case, for example, of the conversion of an SD (Standard Definition) definition of 720×576 pixels into an HD (High Definition) definition of 920×1080 pixels, or even the conversion of an HD definition to a 4K UHD (Ultra-High Definition) definition of 3840×2160 pixels.

Likewise, some set top boxes are capable of performing downscaling in order to output a signal compatible with the resolution of the display screen. That is the case, for example, of a conversion of an UHD TV signal to an HD format. That case is also found on a television set able to send a video stream to a peripheral, the resolution of which is lower (ex: tablet).

Thus, to “smooth an image”, it is possible to use either a low pass filter or merely downscaling and upscaling operations with interpolation.

However, with the advent of the (4K) UHD format, some users of viewing terminals (TV, tablet, laptop or portable computer, portable phones) could be hindered by the hyper realism of the images of some scenes displayed in this format. Indeed, UHD has an remarkable image sharpness throughout the depth which exceeds the real vision perceived by a human. Also, depending on the type of scene or multimedia programme, some prefer displaying in a conventional and/or less detailed HD format (for example television report on a surgical operation, newscast with hard scenes . . . ) which does not cause embarrassment.

On the other hand, users can wish different settings of contrast, brightness, sharpness, definition or colorimetry depending on the type of programme. Yet, settings of the final rendering of an image in terminals of prior art are generally made from configuration menus of these terminals. It is often possible to define a setting of all the parameters as a function of the source being used (internal TNT tuner, HDMI socket, analogue inputs). However, generally, only colour contrast, brightness and saturation can be directly modified by means of a remote control by “+” and “−” keys.

These settings typically relate to brightness, contrast, dynamic contrast, colour temperature, colour hues (R/G/B intensity), white balance, noise reduction (reduction of artefacts related to MPEG decoding), sharpness (edge enhancement by adding a fine white line), or even the Gamma correction of the images.

The object of the invention is to provide a solution to automatically adapt the final rendering of the image of a multimedia programme displayed on a screen to characteristics of the multimedia programme or at least one image of said multimedia programme.

### DISCLOSURE OF THE INVENTION

The invention suggests a method for setting the level of definition of at least one image of an audiovisual programme displayed on a screen of a terminal provided with at least one unit for characterising the programme and at least one unit for selecting predefined settings.

The method according to the invention includes the following steps:

the characterising unit automatically acquires metadata attached to said multimedia programme and submits said metadata to said unit for selecting predefined settings,

the characterising unit generates at least one further metadata from an analysis of a displayed image of the current programme, creates, live and on the fly, at least one rule for defining the desired setting of the final rendering of the image as a function of the metadata of the current programme, at least one of the rules thus created being intended to define the desired setting of the final rendering of the image as a function of the further metadata, and submits said metadata to the unit for selecting predefined settings,

the unit for selecting predefined settings automatically selects the settings according to pre-recorded rules defined as a function of the values of said metadata.

The metadata attached to said programme are representative of at least one of the following parameters:

a title of programme,

a type of programme,

a moral level of programme, and

a summary of programme.

Preferentially, the metadata attached to said programme are extracted from a broacast programme guide (EIT).

In a first alternative implementation of the method according to the invention, the metadata attached to the programme are obtained online from a remote server.

In a second alternative, the method according to the invention includes a step of generating at least one further metadata from an analysis of the image.

The method according to the invention further includes a prior step of determining the pre-recorded rules.

The capture of these predefined settings is typically made by actually adjusting the settings on a “test” image of a programme of the given type.

Alternatively, it is possible to make or modify an “in situ” predefined setting, the background of the image letting the current programme appear. In order to facilitate operations, standard default predefined settings can be stored in the configuration data.

In one particular embodiment, the method according to the invention further includes a step of manually selecting the setting of the level of definition from a plurality of predefined settings.

This method is implemented by means of a terminal for viewing at least one image of an audiovisual programme including, at least one screen, at least one unit for characterising the programme, and at least one unit for selecting predefined settings of said image.

According to the invention, the unit for characterising the multimedia programme is adapted to automatically acquire metadata attached to said multimedia programme and to generate at least one further metadata from an analysis of an image displayed of the current programme, to create live and on the fly, at least one rule for defining the desired setting of the final rendering of the image as a function of the metadata of the current programme, at least one of the rules thus created being intended to define the desired setting of the final rendering of the image as a function of the further metadata, and to submit said metadata to the unit for selecting predefined settings, and the unit for selecting predefined settings is adapted to automatically select the settings according to pre-recorded rules defined as a function of said metadata.

The viewing terminal according to the invention includes means for generating at least one further metadata from an analysis of the image to be displayed. Further, the viewing terminal according to the invention includes means for acquiring, online, the metadata related to said programme from a remote server.

In one preferred embodiment, the viewing terminal according to the invention further includes means for performing manual selection of the setting of the level of definition from a plurality of predefined settings

### BRIEF DESCRIPTION OF THE DRAWINGS

Further characteristics and advantages of the invention will appear from the description that follows, given by way of non-limiting example, in reference to the appended figures in which:

FIG. 1 represents an exemplary list of predefined settings of the final rendering of an image according to the invention,

FIG. 2 represents a general architecture illustrating steps and means for implementing the method according to the invention,

FIG. 3 represents a table containing a list of fields used to design rules for selecting a setting of the final rendering of an image.

FIG. 4 illustrates the essential steps of the method according to the invention.

### DETAILED DISCLOSURE OF PARTICULAR EMBODIMENTS

The invention will be described in the case of viewing on a screen 2 of a television set 4 of an audiovisual programme 6 broacast or read from a recording medium (hard disk, DVD, USB key . . . ).

In a first step, the user defines settings for images which will be then used automatically or in a direct selection.

It is to be noted that the automatic mode can be activated by a dedicated key on the terminal or on a remote control, or in the list of predefined settings that can be scrolled by the “SCREEN PRESET” (AUTO-PRESET1→PRESET2→ . . . →PRESETN→AUTO) key.

By way of non-limiting example, the definition of a presetting (PRESET) is made by the choice of the values of the following parameters:
Brightness (0-100)
Contrast Level (0-100)
Dynamic contrast (O/N)
Colour temperature (Normal, Cold, Warm)
Colour hues (3 R/G/B intensities on values 0-100)
Noise reduction (reduction of artefacts related to MPEG decoding) 0-100
Factors for reducing the source definition (100% to 10%) to “smooth” the image as a function of the source definition (SD, HD720 HD1080, UHD) to 100% the resolution is not reduced
Edge sharpness (edge enhancement by adding a fine white line)
Gamma (−100/+100).

First, the user defines a list of predefined settings for images.

The capture of these settings is typically made by actually adjusting the settings on a “test” image of a programme of the given type.

Alternatively, it is possible to perform or modify an “in situ” predefined setting, the background of the image letting the current programme appear.

In order to facilitate operations, standard default predefined settings can be stored in the configuration data.

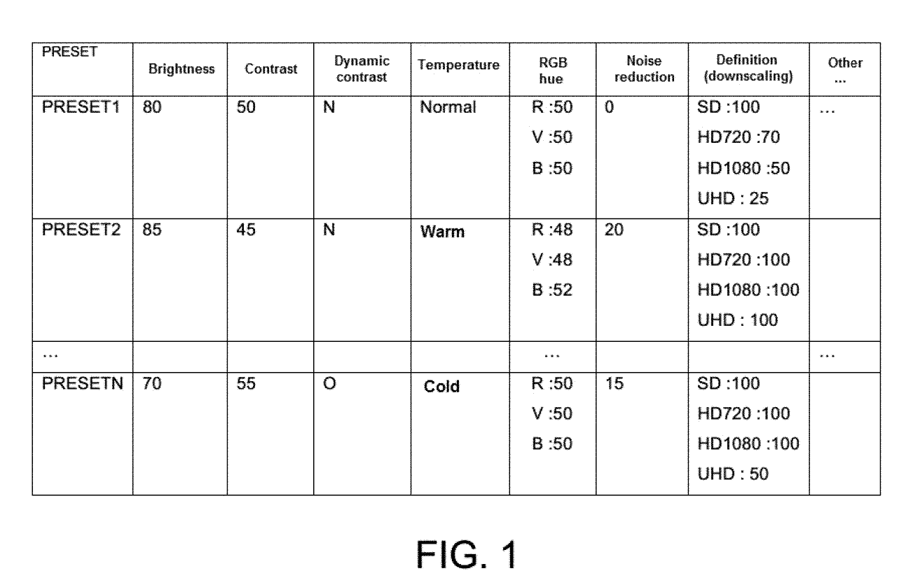

The table of FIG. 1 represents an exemplary list of these predefined settings.

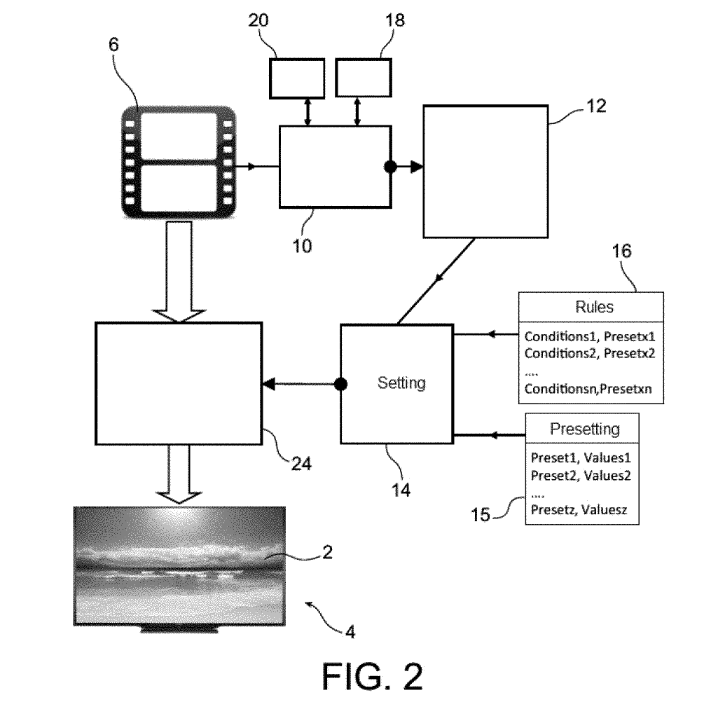

In reference to FIG. 2, a programme characterising unit 10 acquires metadata 12 which will be used by a unit 14 for selecting predefined settings to apply rules 16 for defining the desired setting of the final rendering of the image. The metadata 12 are typically acquired by reading, or extracting, from EPG (Electronic Programme Guide) data 18 broacast with the programme, in the EIT (Event Information Table) enabling information to be obtained, such as the type of programme (Film, Sports, Information . . . ), summary/synopsis, genre(s) (Action, Drama) as well as complementary information (actors, directors). The television channel number and current time can be used to obtain this information on the current programme.

In another alternative, the metadata are obtained upon request to a remote server, typically online through the Internet, if the terminal has a connection, via a SOA (Service Oriented Architecture) web service 20. To that end, the television channel, date and time parameters, or an identifier of multimedia programme “content id” extracted from the EIT, or, alternatively, an automatic recognition mechanism for a multimedia programme ACR (Automatic Content Recogniser) is used. By way of example, when the programme is a film, complementary data about the film can be obtained on sites such as “Imdb.com”.

After acquiring the metadata 12, the unit 14 for selecting predefined settings exploits, based on this metadata, at least one rule from the rule list 16. This exploitation is made according to a given order. Each rule associates a Boolean expression on each metadata 12 to one of the predefined image settings to define the desired setting. The unit 14 for selecting predefined settings then provides the parameters of the predefined setting which is selected.

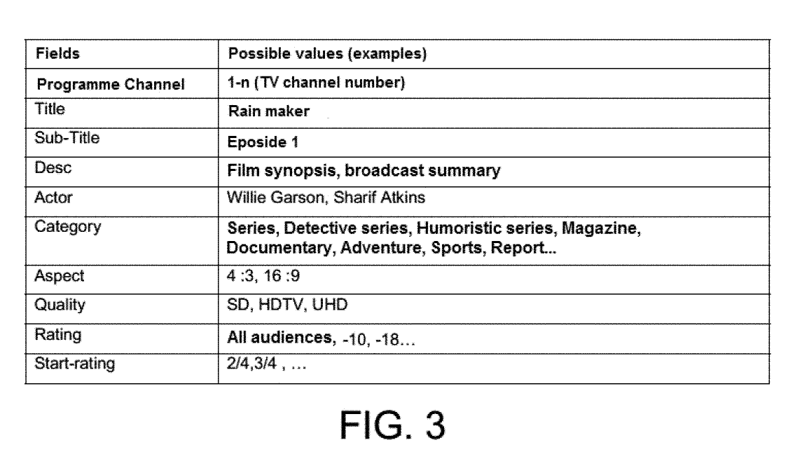

The table of FIG. 3 illustrates an exemplary list of fields used to design the rules for selecting a predefined setting of the final rendering of an image.

Some fields can contain a list of values and are repeated.

An example of metadata including the fields defined in the table of FIG. 3 are given hereinafter.

<program channel=“9” stop=“20150216004500”
start=“20150216000000”>
<title>Rain maker</title>
<sub-title>Episode 8</sub-title>
<desc lang=“fr”>Season: 1 - Episode: 8/14 - During a game of chess,
Mozzie speculates. He thinks that Peter knows where Kate is. Neal is
dubitative. He does not have much time to go into the question because
he has been offered a new mission. He has to infiltrate a group of Wall
Street corrupt brokers, whose suspicions actions have already reduced
many people to poverty. The FBI has sent an agent to infiltrate them,
unsuccessfully. Neal knows that the failure of this operation could put
an end to his collaboration with the FBI. This time, he has to get it right.
Moreover, for this operation, Peter joins him under
cover...</desc>
<credits><actor>Matthew Bomer</actor>
<actor>Tim Dekay</actor>
<actor>Tiffani Thiessen</actor>
<actor>Sabina Gadecki</actor>
<actor>Alexandra Daddario</actor>
<actor>Willie Garson</actor>
<actor>Kelly AuCoin</actor>
<actor>Sharif Atkins</actor>
</credits>
<date>2010</date>
<category>Series</category>
<category>Detective film</category>
<icon src=”http://programme-tv.premire.fr/var/t7j/images/18793198.jpg”/
><episode-num system=”xmltv_ns”>0.7/14.</episode-num>
<video>
<aspect>16:9</aspect>
<quality>HDTV</quality>
</video>
<rating system=”CSA”><value>All audiences</value>
</rating><star-rating><value>2/4</value>
</star-rating></programme>.

A description of the possible rules is given herein below based on the metadata format defined by the table of FIG. 3.

It is to be noted that a rule is comprised of a Boolean expression including a list of fields, each of the fields being associated with an operator and with a value, and a predefined setting identifier said to be selected by the rule. The result of the evaluation of the Boolean expression of a rule, when it is “TRUE” causes the selection by the rule of the selected predefined setting (PRESET) associated with its Boolean expression. If the result is FALSE, the predefined setting is not selected and the next rule is exploited in an analogous way.

When a field of the same type is repeated in the Boolean expression of a rule, the disjunction (an OR) thereof of the evaluations should be evaluated; on the other hand, the conjunction (an AND) of the evaluations of different fields is evaluated.

Conventional comparison operators (=;>;<;<=;>=;<>; Contains) are used.

The operation “Contains” enables the presence of key words to be detected in the title or description. Thus, the expression (“Football, a sport or a spectacle?”, Contains, “Sport Football”) is true, and the expression (Football, a sport or a spectacle?”, Contains, “Championship football”) is false.

In another alternative implementation of the method according to the invention, a rule can be defined in the BNF (Backus Naur Form) form ((Field, Operator, Value)*, Preset).

### EXAMPLES

((<ProgramChannel>,=, “1”),

(<Category>,=, “Series”),

(<Category>, Contains, “Magazine”), PRESET2)

In this case, “PRESET2” is selected on channel 1, if one of the fields Category is equal to “Series” or if one of them contains “Magazine”.

((<Category>,=, “Film”) ,

(<Category>,Contains, “Film”),

(<Rating>,=,−10), PRESET3))

In this case, “PRESET3” is selected if one of the fields “Category” contains “Film” and if the field Rating is equal to “−10”.

It is also possible to use more complex Boolean expressions with further operators and functions (NOT, XOR, AND, Length( ) . . . ).

Finally, to make the evaluation of the rules in a deterministic mode wherein several rules can be true, these are sorted by decreasing cardinality of the fields being evaluated. Thus, the rules including the highest member of conditions are evaluated before the rules including less conditions. This enables particular cases to be given priority, thus enabling them to be taken into account.

It is to be noted that the order of evaluation of the rules can be modified by the user.

If, at the end of the exploitation of the rule list, no predefined setting has been selected, two behaviours are then contemplatable:
not modifying the setting,
applying a default value “PRESET-D” (which corresponds to a rule not including conditions).

It is to be noted that the user can set the rule list 16 in the configuration menu of the terminal 4 by selecting the predefined fields (<Title>,<Category>,<Actor>). That is made either by capturing the expected values, or by selecting a value in a list when the value field is bounded (for example in the fields <Category> or <Rating>).

In another embodiment of the invention, the rules are created, in live, on the fly as a function of the metadata of the current programme.

To that end, the terminal and/or remote control include a key “rules” which enables the metadata of the current programme to be displayed. The user selects the criteria to be evaluated (fields and values) from the metadata displayed (words in the title, subtitle, value in the category, etc.).

For example:
pressing the key “ ” lets the metadata of the current programme appear;
the arrows make it possible to browse on the words included in the values of the fields, each commonly selected word appearing highlighted;
pressing the key “select” selects the field and the key word highlighted, the field and key word value are added as a condition in the rule under construction,
the key “+” enables the operator used in the latest condition created to be selected from [=,>,<,<=,>=;<>;Contains]
pressing the key “delete” deletes in the rule the latest added condition
the key “record” enables the rule comprised of the list of created conditions to be recorded and suggests to select the value of predefined setting “PRESETx” by using the arrows (the effect is thereby immediately visible on the programme in the background).

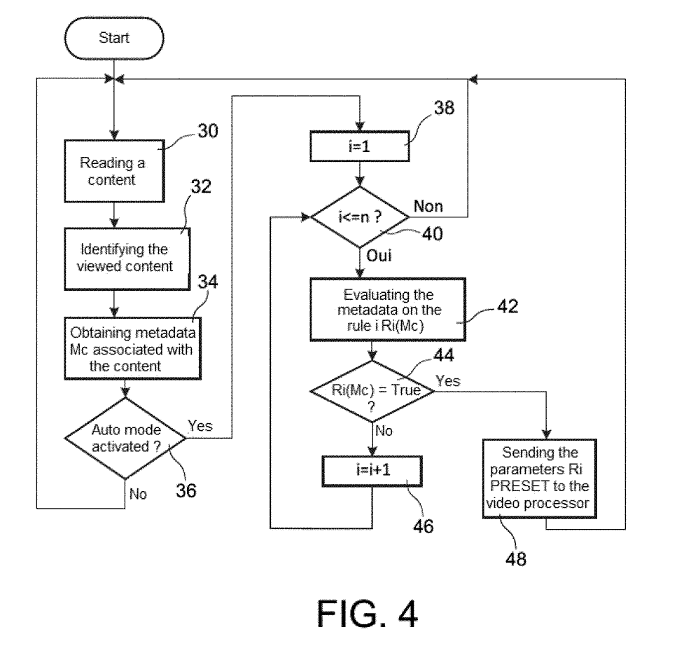

FIG. 4 illustrates the essential steps of the method according to the invention.

In step 30, the terminal triggers the reading of a multimedia programme.

The programme characterising unit 10 integrated to the receiver terminal or to a set-top-box identifies the multimedia programme in step 32.

In step 34, the programme characterising unit 10 acquires the metadata associated with the multimedia programme, and then transmits them to the unit 14 for selecting predefined settings.

This tests, in step 36, whether the automatic mode is activated or not.

If the automatic mode is not activated, the user manually performs on the fly the settings of the image by successively pressing on a key intended to that end on the remote controller as described below:
quick depressions (first delay lower than 0.5 second) on the key “SCREEN PRESET” cause the predefined settings of PRESET1→PRESET2→ . . . →PRESETN→PRESET1 to switch
an identifier of the active predefined setting appears on the screen in overlay,
after a second delay longer than 0.5 second, the latest active predefined setting is selected and applied to the video signal (on the graphics processor of the television set or the Set Top Box),
the identifier of the predefined setting thus selected then disappears from the screen.
   It is to be noted that the durations of the first and the second delay can be modified.

This first approach enables a predefined setting to be quickly switched to another without entering the complexity of system menus.

In a preferred embodiment of the invention, the automatic mode is activated by default so as to automatically apply a predefined setting as a function of a characterisation of the programme being viewed. In this case, after step 36, if the rule list includes in number n of rules, these are successively exploited with an increasing rank i order from 1.

Thereby, i is set to 1 in step 38.

In step 40, it is tested whether all the rules have been examined.

If this test is negative, in step 42, the Boolean expression of the commonly exploited rule with a rank i of the rule list is evaluated, on the metadata Mc.

In step 44, the result of step 42 is tested.

If this result indicates a “FALSE” value, that is if the Boolean expression of the rule Ri applied to the metadata Mc is not satisfied, then the next rule of the list at the metadata Mc is exploited in an analogous way, after incrementing i in step 46 and a new implementation of step 40, during a new implementation of step 42.

If the Boolean expression of the rule Ri applied to the metadata Mc is satisfied, then the parameters of the selected predefined setting of the rule Ri are sent to the microprocessor 24.

In another alternative embodiment, the setting of the final rendering of the image can be completed with a sound setting according to a quite similar principle. Depending on the programme (Musical, Information cast news, Film), a sound profile is automatically selected, promoting for example voice, Dolby Digital sound, stereo . . . .

Another possible alternative is to generate further metadata by analysing the image (recognition of object, scene type, such as action etc.).

For the method to be applicable to recorded multimedia programmes, the metadata have to be optionally recorded with the multimedia programme.

Finally, if a multimedia programme provided without metadata is read, it is possible by using fingerprinting or watermarking to identify it and to acquire then, optionally, from a server the corresponding metadata (Base ImdB, or Gracenote system) without departing from the scope of the invention.

1-13. (canceled)

14. A method for setting the level of definition of at least one image of a multimedia programme displayed on a screen (2) of a terminal (4) provided with at least one unit (10) for characterizing the multimedia programme and at least one unit (14) for selecting predefined settings, in which method,
the characterising unit (10) automatically acquires metadata attached to said multimedia programme and submits said metadata to the unit (14) for selecting predefined settings,
the characterising unit (10) generates at least one further metadata from an analysis of a displayed image of the current programme, creates, live and on the fly, at least one rule for defining the desired setting of the final rendering of the image as a function of the metadata of the current programme, at least one of the rules thus created being intended to define the desired setting of the final rendering of the image as a function of the further metadata, and submits said metadata to the unit for selecting predefined settings,
the unit (14) for selecting predefined settings automatically selects the settings according to pre-recorded rules and/or the live on-the-fly defined rule, characterised in that said further metadata is generated from an object and/or scene type recognition.

15. The method according to claim 14, wherein the metadata attached to said multimedia programme are representative of at least one of the following parameters:
a title of multimedia programme,
a type of multimedia programme,
a genre of multimedia programme,
a moral level of multimedia programme, and
a summary of multimedia programme.

16. The method according to claim 15, wherein the metadata attached to said multimedia programme are extracted from a broadcast multimedia programme guide (EIT).

17. The method according to claim 15, wherein the metadata relating to said multimedia programme are obtained online from a remote server.

18. The method according to claim 14, further including a step of pre-recording defined rules as a function of values of said metadata.

19. The method according to claim 18, further including a step of manually selecting the setting of the level of definition from a plurality of predefined settings.

20. The method according to claim 18, further including a step of setting the level of definition of at least one audio component of the multimedia programme.

21. A viewing terminal for viewing at least one image of a multimedia programme including a screen (2), at least one unit (10) for characterising the multimedia programme, and at least one unit (14) for selecting predefined settings for said image, wherein
the unit (10) for characterising the multimedia programme is adapted to automatically acquire metadata attached to said multimedia programme and to generate at least one further metadata from an analysis of an image displayed of the current programme, to create live and on the fly, at least one rule for defining the desired setting of the final rendering of the image as a function of the metadata of the current programme, at least one of the rules thus created being intended to define the desired setting of the final rendering of the image as a function of the further metadata, and to submit said metadata to the unit (11) for selecting predefined settings, and,
the unit (14) for selecting predefined settings is adapted to automatically select the settings according to pre-recorded rules and/or the live on-the-fly defined rule, viewing terminal characterised in that it further includes means for generating at least one further metadata from an analysis of the image.

22. The viewing terminal according to claim 21, further including means for performing manual selection of the setting of the level of definition from a plurality of predefined settings.

23. The viewing terminal according to claim 22, further including means for acquiring, online, the metadata relating to said multimedia programme from a remote server.

24. A computer programme stored on a recording medium including instructions for implementing the steps of the method according to claim 14 when run on a computer.
